(19) United States
(12) Patent Application Publication
(10) Pub. No.: US 2021/0354493 A1
(43) Pub. Date: Nov. 18, 2021

(54) Heating System for Sublimation Printing

(71) Applicant: Hewlett-Packard Development Company, L.P., Spring, TX (US)

(72) Inventors: Xavier Oliva Ventayol, Sant Cugat del Valles (ES); Francisco Lopez Moral, Sant Cugat del Valles (ES); Jose Luis Valero Navazo, Sant Cugat del Valles (ES)

(73) Assignee: Hewlett-Packard Development Company, L.P., Spring, TX (US)

(21) Appl. No.: 17/258,486

(22) PCT Filed: Feb. 6, 2019
(86) PCT No.: PCT/US2019/016756

§ 371 Date: Jan. 7, 2021

(51) Int. Cl. B41M 5/035; F24H 3/04

(52) U.S. Cl. CPC B41M 5/0358; F24H 3/0482

(57) ABSTRACT

Disclosed herein is a method of sublimation printing, a heating system for sublimation printing and a printing device. The method of sublimation printing comprises generating an air flow through a print medium on which a printing substance is deposited and heating the air flow to a temperature at or above a sublimation temperature of the printing substance.

### BACKGROUND

Sublimation printing enables printing on textiles like garment fabrics. For this, sublimation inks may be used, which can be sublimated and absorbed by fibers of the textile to permanently imprint an ink pattern in the textile.

### BRIEF DESCRIPTION OF DRAWINGS

In the following, a detailed description of various examples is given with reference to the figures. The figures show schematic illustrations of

FIG. 1: a flow chart of a method of sublimation printing according to an example;

FIG. 2: a heating system for sublimation printing in accordance with an example;

FIG. 3a: a heating system for sublimation printing with a removably connected frame according to an example;

FIG. 3b: the heating system of FIG. 3a with the frame detached;

FIG. 4: a printing device with independent printing and heating subsystems in accordance with an example; and

FIG. 5: a printing device with an actuator according to an example.

### DETAILED DESCRIPTION

Sublimation printing on textiles relies on the absorption of a gaseous printing substance by textile fibers to permanently imprint patterns in textiles. For this, a sublimation printing substance may be deposited on or transferred to the textile and the textile may be heated to sublimate the printing substance. The sublimated printing substance may be absorbed by the heated fibers and may be integrated into the material of the fibers itself after cooling down, resulting in printed patterns with a high durability.

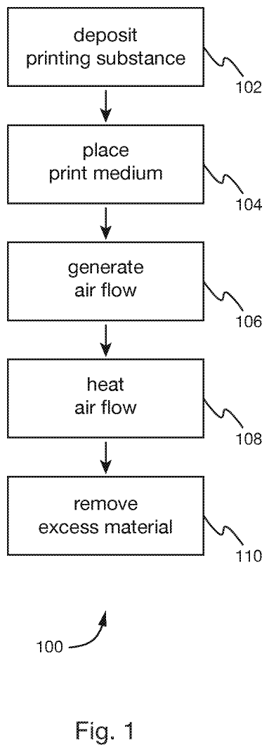

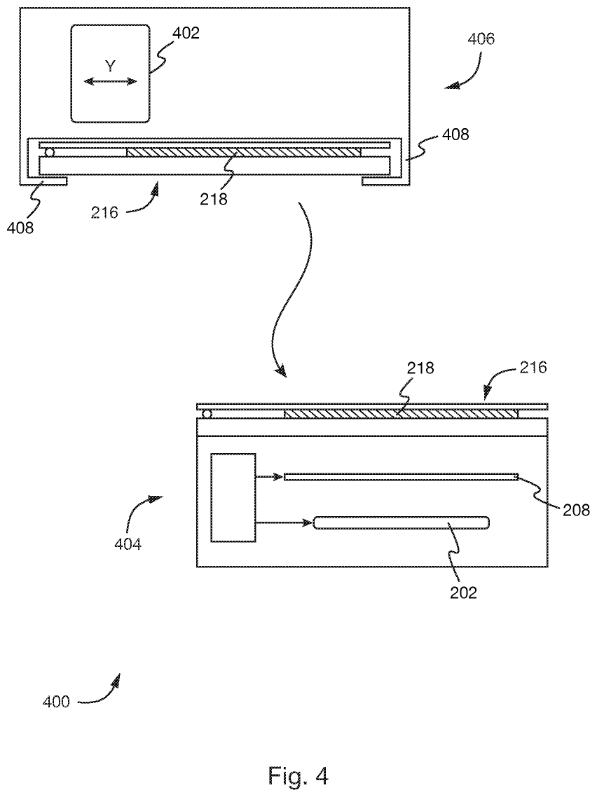

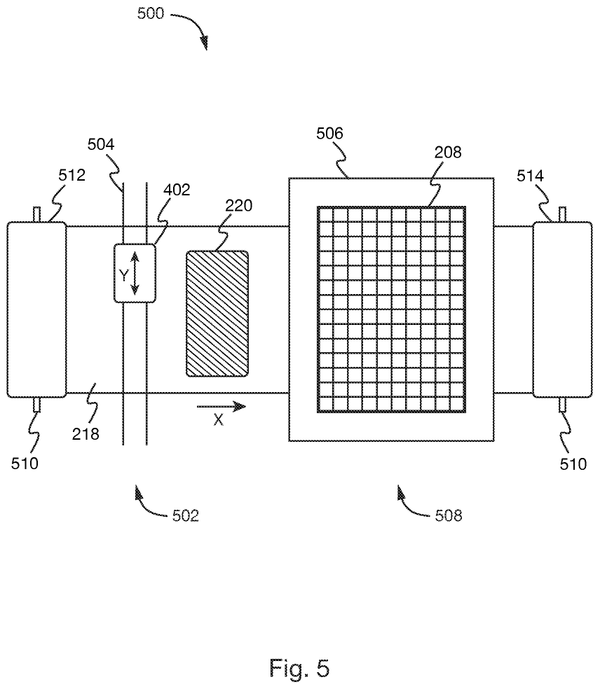

FIG. 1 depicts a flow chart of a method 100 of sublimation printing according to an example. The method 100 may for example be implemented with one of the printing devices 400 and 500 described below with reference to FIGS. 4 and 5, respectively, or with another suitable heating system and/or printing device.

The method 100 may comprise, in 102, depositing a sublimation printing substance such as a printing fluid on a print medium, e.g. on a front side of the print medium. The print medium may for example be a abric or textile, e.g. a garment abric, or a medium comprising plastic or paper, e.g. polymer-coated plastic or paper. The print medium may comprise fibers, e.g. synthetic fibers like nylon or polyester, natural fibers like cotton or wool, or a combination thereof. The constituents of the print medium may have a melting point above 250° C. and may absorb gaseous printing substance when heated. In one example, the print medium may be a polyester fabric. The print medium may have been treated or coated with an absorbing substance that absorbs gaseous printing substance when heated, e.g. a polymer. In some examples, the print medium may be a piece of textile, e.g. a flag or a piece of clothing like a T-shirt. In other examples, the print medium may be a continuous web of textile, from which pieces of textile may e.g. be cut after the sublimation printing. The continuous web of textile may for example be rolled up at least in part, e.g. on a plain material roll on which a plain part of the print medium is rolled up that has not yet been printed on and/or on a printed material roll on which a printed part of the print medium is rolled up that has already been printed on.

The sublimation printing substance is a substance that becomes gaseous above a sublimation temperature. The sublimation printing substance may be a sublimable substance that is solid below the sublimation temperature, e.g. a sublimation ink. In other examples, the sublimation printing substance may be liquid or partially liquefied below the sublimation temperature. The sublimation temperature of the printing substance may be adapted to the print medium, e.g. such that the sublimation temperature is equal to a temperature below a melting point of the print medium or constituents thereof at which the print medium or constituents thereof exhibit an increased absorption rate of the printing substance, e.g. a maximum in the absorption rate. The printing substance may have a single color or may comprise multiple colors.

The printing substance may be deposited on the print medium without using a protective paper and without using a sublimation or transfer paper. A sublimation or transfer paper is an intermediate medium, on which the printing substance is deposited first in a pattern that is subsequently to be transferred to the print medium. The printing substance may for example be deposited by printing directly on the print medium, e.g. with a movable print head comprising nozzles, from which the printing substance may be ejected onto the print medium. By not using a protective paper and/or a transfer paper, ghosting effects may be reduced. Ghosting effects may for example be created when removing a protective or transfer paper, in particular when the paper is hot, as printing substance trapped between the print medium and the paper may unintentionally be deposited on the print medium, e.g. by accidentally bringing the paper in contact with the print medium during removal. In one example, the printing substance may be dissolved in a fluid for depositing the printing substance, e.g. to facilitate the printing. The method 100 may further comprise drying the printing substance on the print medium, e.g. by waiting for the fluid to evaporate. In some examples, the printing substance may already have been deposited on the print medium prior to performing the method 100 and execution of 102 may be omitted.

The method 100 may further comprise, in 104, placing the print medium in or adjacent to a heating system, e.g. to heat the print medium to sublimate the printing substance. This may comprise placing the print medium on or in a support structure, e.g. a frame of the heating system. The frame is just one example of a support structure and other types of support structures, including a table, could be used. In some examples, the print medium may already be placed on or mounted in a frame for depositing the printing substance in 102. The heating may be performed in this frame at the same position as the deposition of the printing substance at 102, or 104 may comprise transferring the frame holding the print medium into or adjacent to the heating system. Additionally or alternatively, 104 may comprise moving the print medium from a printing zone, in which the printing substance is deposited on the print medium, to a sublimation zone at the heating system. In the heating zone and the printing zone, the same or different support structures can be used for holding the print medium. In some examples, in which a continuous web of textile is used, the print medium may for example be moved by rotating a roll on which a part of the print medium is rolled up, e.g. the plain material roll and/or the printed material roll, without the use of a frame.

The method 100 comprises, in 106, generating an air flow through the print medium on which the sublimation printing substance has been deposited. The air flow passes through the print medium at least in part. In one example, a flow rate of the air flow after passing through the print medium may be more than 5%, in another example more than 20% of the flow rate of the air flow prior to passing through the print medium, wherein the flow rate is the product of the cross-sectional area and velocity of the air flow. The printing substance may e.g. be deposited on the front side of the print medium. The air flow may for example pass through the print medium from a backside of the print medium to the front side of the print medium. The air flow through the print medium may be generated without applying pressure to the print medium in a direction perpendicular to the print medium surface in addition to the pressure generated by the air flow, e.g. to avoid press marks on the print medium. Press marks e.g. could be created by a press or calender machine used to apply pressure and heat to the print medium. This can be avoided by the method and the device described herein.

The air flow may for example have a velocity between 1 m/s and 10 m/s before passing through the print medium. A cross-section of the air flow may be adapted to a print area on the print medium in which the printing substance is deposited, e.g. to ensure a uniform temperature and/or velocity distribution of the air flow over the print area. The cross-sectional area may be larger than the print area, e.g. by a margin between 0.5 cm to 20 cm in every direction. In one example, the print area may have a size between 1 cm² and 1 m² and the cross-sectional area of the air flow may have a size between 50 cm² and 1.5 m² to provide an air flow margin around the print area. Accordingly, a flow rate of the air flow before passing through the print medium may be between 0.005 m³/s and 15 m³/s.

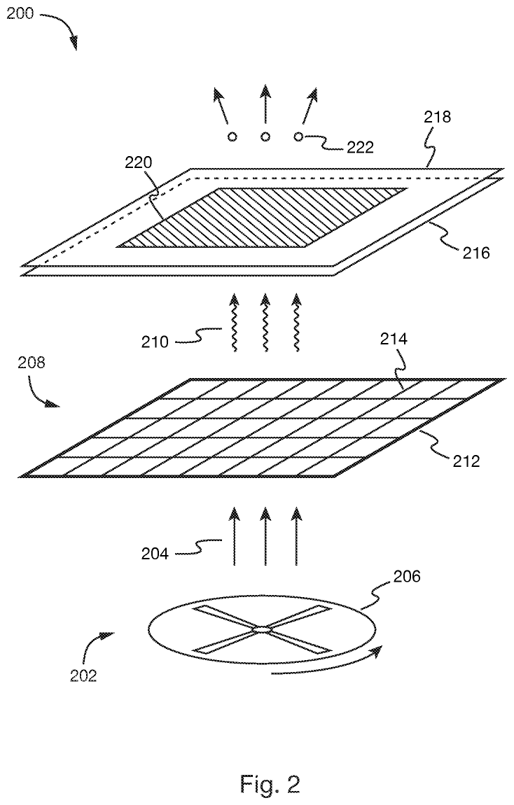

The air flow may for example be generated with a fan, e.g. as described below with reference to FIG. 2. In other examples, the air flow may be generated using pressurized air from a reservoir or by creating a pressure difference between a reservoir and the surrounding environment, e.g. using a pump. The air flow also may be generated from a pneumatic source.

In 108, the air flow is heated to a temperature at or above a sublimation temperature of the printing substance, e.g. to sublimate the printing substance deposited on the print medium. Using an air flow may allow for sublimating the printing substance without using a press or calender machine and without requiring protective paper. This may further reduce ghosting effects, which may for example occur when using a protective paper. The sublimation temperature of the printing substance may for example be in the range between 150° C. and 250° C., in one example between 190° C. and 210° C. The air flow may be heated to a temperature that is between 20° C. and 150° C. above the sublimation temperature, for example to ensure that a temperature of the air flow when passing through the print medium is above the sublimation temperature, e.g. such that the air flow may heat the print medium to a temperature at or above the sublimation temperature. In one example, the air flow is heated to a temperature between 200° C. and 300° C. The temperature that the airflow is heated to may be adapted to the print medium, e.g. to avoid damaging the print medium. In one example, the airflow is heated to a temperature below the melting point of the print medium.

The air flow may for example be heated by passing through a heating grid which is heated as described below with reference to FIG. 2. In other examples, the air may be heated when or prior to generating the air flow, e.g. by heating the reservoir containing pressurized air. The heating may for example be performed using resistive heating elements, inductive heating elements, by circulating a heating medium, e.g. a hot fluid, in a heat exchanger, or by burning a heating substance, e.g. natural gas.

The method 100 may further comprise, in 110, at least partially removing excess printing substance from the print medium by the air flow, e.g. to avoid ghosting images. For this, the air flow may be generated such that the air flow passes through the print medium from the backside to the front side, if the printing substance is deposited on the front side, e.g. by placing the print medium appropriately in 104. A temperature, velocity or flow rate of the air flow may for example be chosen such that particles and/or droplets of the printing substance which have not been absorbed by the print medium are blown away or evaporated by the air flow at least in part. The velocity or flow rate of the air flow may in particular be chosen such that the particles and/or droplets that are removed from the print medium do not return to the print medium, e.g. to avoid ghosting images due to particles and/or droplets dropping down on the print medium. This may comprise changing a direction of the air flow after the air flow has passed through the print medium, e.g. using a fan. In one example, the air flow that has passed through the print medium may be extracted using an exhaust hood or fume hood.

The method 100 may further comprise maintaining the air flow. The air flow may for example be maintained for 5 to 30 seconds, in one example for 10 to 15 seconds. In one example, the air flow is maintained until a temperature of the print medium is equal to or exceeds the sublimation temperature of the printing substance. The temperature, velocity, volume and/or cross-section of the air flow may be constant while maintaining the air flow. In other examples, the temperature, velocity, volume and/or cross section of the air flow may be adjusted while maintaining the air flow. In one example, the flow rate of the air flow may be increased, e.g. using a lower flow rate initially to heat the print medium and a higher flow rate later on to facilitate removal of excess printing substance. Alternatively or additionally, the temperature of the air flow may for example be decreased while maintaining the air flow, e.g. to facilitate absorption of the printing substance by the print medium.

The method 100 may be executed and modified in various ways, e.g. by omitting parts or by adding additional parts. In particular, the flow diagram shown in FIG. 1 does not imply a certain order of execution for the method 100. As far as technically feasible, the method 100 may be performed in any order and different parts may be performed simultaneously at least in part. For example, the blocks 106 and 108 may be performed simultaneously, i.e. the air flow may be heated continuously while the air flow is being generated. In another example, blocks 102, 104, 106, and 108 may be performed simultaneously, e.g. when using a continuous print medium.

FIG. 2 depicts a schematic illustration of a heating system 200 in accordance with an example, which may for example be used for implementing the method 100. The heating system 200 comprises a flow generator 202 to generate an air flow 204. The flow generator 202 may for example generate the air flow 204 with a velocity of 1 m/s to 10 m/s and a cross-sectional area perpendicular to the direction of motion of the air flow 204 between 50 cm² and 1.5 m², corresponding to a flow rate of the air flow between 0.005 m³/s and 15 m³/s. The flow generator 202 may comprise a fan 206 to generate the air flow 204, e.g. an electrically powered fan. The fan 206 may for example have a plurality of blades with a diameter between 5 cm and 50 cm, which may e.g. rotate with a velocity of 100 to 5000 revolutions per minute. In one example, the flow generator 202 may comprise a plurality of fans. In other examples, the flow generator 202 may comprise a reservoir to contain pressurized air to generate the air flow 204, e.g. through an opening of the reservoir. The flow generator 202 may further comprise a fan or pump to generate and/or maintain a pressure in the reservoir.

The heating system 200 further comprises a heater 208 to heat the air flow 204. The heater 208 may for example be arranged such that the air flow 204 passes through the heater 208, generating a heated air flow 210. In another example, the heater 208 may be arranged such that the heater 208 heats incoming air flowing towards the fan 204 to generate the heated air flow 210. In yet another example, the heater 208 may be arranged in a reservoir of the flow generator 202 or in a side wall of a reservoir of the flow generator 202.

The heater 208 may for example comprise a heating grid 212, which may e.g. be arranged such that the air flow 204 passes through the heating grid 212. The heating grid 212 may comprise a heating element 214, wherein the heating element 214 may for example be arranged in a regular grid, e.g. a rectangular grid as shown in FIG. 2. Alternatively or additionally, the heating element 214 may comprise a winding or meandering segment. In one example, the heating grid 212 may be formed by a plurality of heating elements. The heating grid 212 may further comprise a perforated plate, e.g. a perforated plate in which the heating element 214 is arranged. In other examples, the heating grid 212 may additionally comprise a heat distribution element, e.g. a rod or plate comprising a heat-conducting material like copper that is in thermal contact with the heating element 214. The heat distribution element or a plurality of heat distribution elements may for example be arranged in a grid.

The heating element 214 may e.g. be a resistive electric heating element, through which a current may be passed to heat the heating element 214. The heating element 214 may for example comprise of metal, in particular a metallic alloy, ceramic or a combination thereof. The heating element 214 may in particular be a resistive heating element having a material with an electric resistance with a positive temperature coefficient, i.e. with an electric resistance that decreases with increasing temperature, e.g. a ceramic comprising barium titanate or lead titanate. For example, the heating element may comprise a heating wire. In other examples, the heating element 214 may comprise a tube through which a heating medium circulates, e.g. a hot fluid. In one example, the heater 208 may additionally or alternatively comprise a burner, e.g. to burn a heating substance like natural gas. The heating element 214 may for example be heated to a temperature between 300° C. and 1000° C., e.g. such that the temperature of the heated air flow 210 is above 200° C., e.g. between 200° C. and 300° C.

The heating device 200 also comprises a frame 216 to support an air-permeable print medium 218 such that the heated air flow 210 passes through the print medium 218. As described above, the print medium 218 may for example be a textile or may e.g. comprise or consist of polymer-coated plastic or polymer-coated paper. The print medium 218 may comprise a print area 220, in which a sublimation printing substance is deposited, e.g. on a front side of the print medium 218. The frame 216 may comprise an outer portion to support the print medium 218 and an inner region through which the air flow 210 can pass, e.g. a cut-out or a grid or perforated area or the like, in the following all referred to as cut-out. The outer portion may e.g. be a dosed frame surrounding the cut-out at the center, for example. a rectangular or circular frame, or an open frame with a cut-out from one or more sides, wherein the frame 216 is arranged such that the heated air flow 210 passes through the cut-out. The cutout may e.g. have a rectangular or circular shape.

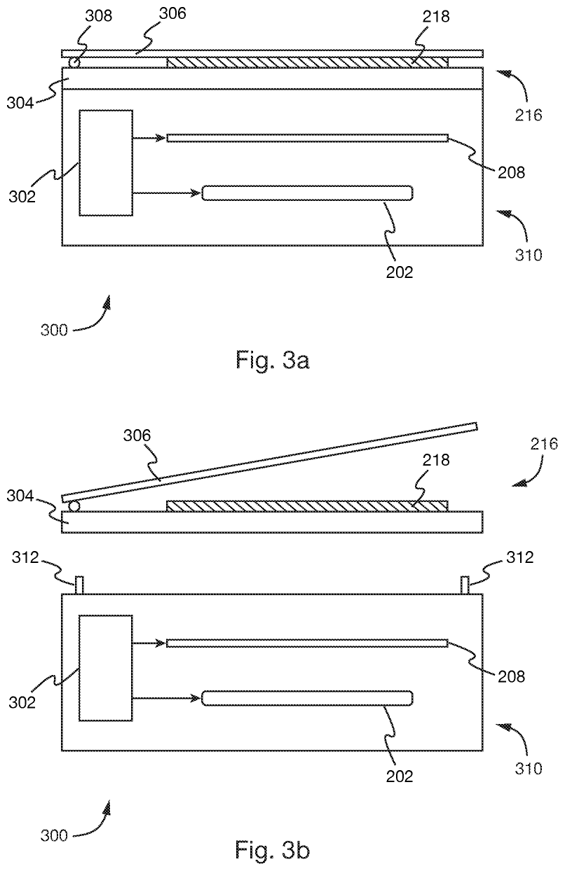

The frame 216 may further comprise a mount to fix the print medium 218, e.g. to prevent the heated air flow 210 from displacing the print medium 218. An example for this is described below with reference to FIG. 3. The frame 216 may hold the print medium 218 at a fixed distance from the heater 208, e.g. to avoid contact between the print medium 218 and the heating element 214. In one example, the frame 216 may hold the print medium 218 such that a distance between the print medium 218 and the heater 208 is between 1 cm and 10 cm.

A temperature, velocity or flow rate of the heated air flow 210 may for example be chosen such that excess particles or droplets 222 of the printing substance are removed from the print medium 218 at least in part. In some examples, the frame 216 may comprise a funnel, e.g. to increase a velocity of the heated air flow 210 before passing through the print medium 218. The print medium 218 may be placed on the frame 216 such that a side of the print medium 218 on which the printing substance is deposited, e.g. the front side, is facing in the flow direction of the heated air flow 210, i.e. such the heated air flow 210 passes through the print medium 218 from a back side to the front side.

FIG. 3a depicts another example of a heating system 300. Similar to the heating system 200, the heating system 300 comprises a flow generator 202 to generate an air flow 204 and a heater 208 to heat the air flow 204. The heating system 300 further comprises a controller 302 to control the flow generator 202 and/or the heater 208, e.g. to adjust a velocity, volume, pressure and/or a temperature of the heated air flow 210. The flow generator 202 may for example comprise a fan 206 and the controller 302 may adjust a fan speed of the fan 206, e.g. to control a velocity or flow rate of the air flow 204.

In one example, the heating system 300 may comprise a sensor coupled to the controller 302 to determine the velocity or flow rate of the air flow 204 and the controller 302 may control the velocity or flow rate using a feedback loop. The heater 208 may for example comprise a resistive heating element 214 and the controller 302 may adjust a current through the resistive heating element 214, e.g. to control a temperature of the heated air flow 210. Alternatively, the controller 302 may adjust a flow rate and/or a temperature of a heating medium in the heater 208. In one example, the heating system 300 may comprise a temperature sensor coupled to the controller 302 to determine the temperature of the heated air flow 210 and the controller 302 may control the temperature using a feedback loop.

The frame 216 of the heating system 300 comprises a mount to fix the print medium 218, e.g. to prevent the heated air flow 210 from dislocating the print medium 218. The frame 216 may for example comprise a lower part 304, on which the print medium 218 may be placed. The lower part 304 may e.g. be similar to the frame 216 of the heating system 200, i.e. the lower part 304 may comprise an outer portion to support the print medium 218 and an inner region, e.g. a cutout, through which the heated air flow 210 passes. To fix the print medium 218, the frame 216 may comprise an upper part 306 to retain the print medium 218, e.g. by pressing the print medium 218 against the lower part 304. The upper part 306 may for example be arranged such that the upper part 306 is adjacent to or in contact with a portion of the print medium 218 outside of the print area 220. The upper part 306 may have a similar shape as the lower part 304 and may for example be a closed or open frame. In other examples, the upper part 306 may comprise a retaining bar or hook, e.g. one retaining bar arranged above a side portion of the lower frame part 304 and another retaining bar arranged above an opposing portion of the lower frame part 304. The upper part 306 may be movably or detachably connected with the lower part 304, e.g. by a hinge 308 such that the frame 216 may be pivotally opened to insert or remove the print medium 218 as shown in FIG. 3b.

In some examples, the frame 216 may be removably connected to the heating system 300 as illustrated in FIGS. 3a and 3b. FIG. 3a depicts the heating system 300 in a state, in which the frame 216 is attached to a main body 310 of the heating system 300, whereas FIG. 3b depicts the heating system 300 a state, in which the frame 216 is detached from the main body 310. The main body 310 may for example comprise connection pins 312, on which the frame 216 can be placed. The frame 216 may comprise recesses or holes to engage the connection pins 312, e.g. to prevent the frame 216 from moving when generating the air flow 204. In other examples, the main body 310 may comprise clips or hooks to removably attach the frame 216 to the main body 310.

FIG. 4 depicts a printing device 400 in accordance with an example. The printing device 400 comprises a print head 402 to deposit a sublimation printing substance on an air-permeable print medium 218, e.g. such that no sublimation or transfer paper is required. The print head 402 may for example be an ink-jet print head having a reservoir for the sublimation printing substance, e.g. a sublimation ink, and a nozzle plate for depositing the printing substance directly on the print medium 218. The printing device 400 further comprises a heating subsystem 404 to heat the print medium 218. The heating subsystem 404 may for example be similar to the heating system 300 shown in FIG. 3 and comprises a flow generator 202 to generate an air flow 204 through the print medium 218 and a heater 208 to heat the air flow 204.

In the example shown in FIG. 4, the print head 402 is part of a printing subsystem 406 of the printing device 400. The printing subsystem 406 may comprise an actuator for moving the print head 402, e.g. an electric motor coupled to the print head 402 via a belt drive or a gear drive. The print head 402 may e.g. be movable along a print head path in one direction as illustrated by the arrow labeled “Y” in FIG. 4. In other examples, the print head 402 may be movable in two or three directions. The print medium 218 may be placed in the printing subsystem 404 below the print head 402. In some examples, the printing subsystem 406 may also comprise an actuator for moving the print medium 218.

The printing subsystem 406 and the heating subsystem 404 may be independent systems that operate autonomously independent of each other. In particular, the printing subsystem 406 and the heating subsystem 404 may be portable autonomous systems. In some examples, the printing subsystem 406 and/or the heating subsystem 404 may have a weight of less than 20 kg, in one example less than 10 kg, and may have a size of less than 1 m, in one example less than 0.5 m, in every direction.

The printing device 400 may further include a frame 216 to support the print medium 218. The frame 216 may e.g. be used to place the print medium 218 such that the heated air flow 210 generated by the heating subsystem 404 passes through the print medium 218. The frame 216 may be similar to the frame 216 of the heating system 300 described above. In particular, the frame 216 may fix the print medium 218, for example through an upper part 306 as described above with reference to FIG. 3a, e.g. to fix the print medium 218 such that the heated air flow 210 passes through the print medium 218.

The frame 216 may be detachably connected to the heating subsystem 404 and/or the printing subsystem 406. The frame 216 may be detachably connected to both the heating subsystem 404 and the printing subsystem 406. This may for example allow for mounting the print medium 218 in the frame 216, placing the frame 216 in the printing subsystem 406 for depositing the printing substance on the print medium 218, subsequently moving the frame 216 from the printing subsystem 406 to the heating subsystem 404 and connecting the frame 216 to the heating subsystem 404 for sublimating the printing substance on the print medium 218. Thereby, the print medium 218 may be aligned properly for depositing the printing substance as well as for sublimating the printing substance without requiring time-consuming to alignment in between.

The frame 216 may for example be detachably connected to the heating subsystem 404 and/or the printing subsystem 406 as described above for the heating system 300, e.g. via connecting pins 312, clips and/or hooks. In one example, the printing subsystem 406 may comprise rails or hooks 408 to removably place the frame 216 below the print head 402. The rails 408 may for example be arranged on opposing sides of a bottom face of the printing subsystem 406, e.g. such that the frame 216 may slide in and out of the printing subsystem 406. The frame 216 may be connected to the heating subsystem 404 and the printing subsystem 406 such that the print head 402 deposits the printing substance on a front side of the print medium 218 and that the air flow generated by the printing subsystem 404 passes through the print medium 218 from a backside to the front side, e.g. to facilitate removing excess printing substance from the print medium 218.

FIG. 5 depicts another example for a printing device 500 according to an example. The printing device 500 may for example be a printing device for sublimation printing on large-scale print media such as a continuous web of textile. Similar to the printing device 400, the printing device 500 comprises a print head 402 to deposit a sublimation printing substance or fluid on an air-permeable print medium 218 in a printing zone 502 of the printing device 500. The print head 402 may e.g. deposit the printing fluid on a front side of the print medium 218. The print head 402 may for example be an ink-jet print head as described above. The print head 402 may be movable along a print head path 504 in the printing zone 502 as illustrated by the arrow labeled “Y” in FIG. 5, e.g. to distribute the printing fluid over the print medium 218. To move the print head 402, the printing device 500 may comprise an actuator such as an electric motor.

The printing device 500 further comprises a heating subsystem 506 to heat the print medium 218 in a sublimation zone 508. The heating subsystem 506 comprises a flow generator 202 to generate an air flow 204 through the print medium 218 and a heater 208 to heat the air flow 204. As described above with reference to FIG. 2, the flow generator 202 may e.g. comprise a fan to generate the air flow 204 and the heater 208 may for example comprise a heating grid 212, e.g. a heating grid 212 formed by a resistive electric heating element 214. The printing device 500 may generate the air flow 204 such that the air flow 204 passes through the print medium 218 from a backside to the front side, on which the printing fluid is deposited by the print head 402.

The printing device 500 may further comprise an actuator 510 to move the print medium 218 from the printing zone 502 adjacent to the print head 402 to the sublimation zone 508 adjacent to the heating subsystem 506 as illustrated by the arrow labeled “X” in FIG. 5. In some examples, a plain part of the print medium 218 that has not yet been printed on may be at least partially rolled up on a plain material roll 512 and/or a printed part of the print medium 218 that has already been printed on may be at least partially rolled up on a printed material roll 514. The actuator 510 may e.g. be coupled to the plain material roll 512 and/or the printed material roll 514 and may move the print medium 218 by rotating the plain material roll 512 and/or the printed material roll 514 and/or by rotating drive rollers (not illustrated). Thereby, a print area 220 on the print medium 218, in which printing substance has been deposited, may be advanced from the printing zone 502 to the sublimation zone 508, e.g. to sublimate the deposited printing substance in the air flow 204 generated by the heating subsystem 506.

The actuator 510 may for example move the print medium 218 with a velocity that is adapted to a printing speed of the print head 402. A width of the heated air flow 210 along the X direction may be adapted to the velocity of the print medium 218 such that the heated air flow passes through the print area 220 on the print medium 218 for an appropriate amount of time to sublimate the printing substance and/or to remove excess printing substance as the print medium 218 is moved by the actuator 510. The heated air flow 210 may for example have a width in the Y direction between 0.2 m and 2 m and a length in the X direction between 0.5 m and 5 m. In some examples, each point within the print area 220 may spend between 5 to 30 seconds, in one example between 10 to 15 seconds, in the heated air flow 210.

This description is not intended to be exhaustive or limiting to any of the examples described above. The sublimation printing method, the heating system, and the printing device disclosed herein can be implemented in various ways and with many modifications without altering the underlying basic properties.

1. A method of sublimation printing, the method comprising:
generating an air flow through a print medium on which a sublimation printing substance is deposited; and
heating the air flow to a temperature at or above a sublimation temperature of the printing substance.

2. The method of claim 1, further comprising depositing the printing substance on the print medium.

3. The method of claim 1, wherein the air flow passes a heating grid and wherein heating the to air flow comprises heating the heating grid.

4. The method of claim 1, further comprising at least partially removing excess printing substance from the print medium by the air flow.

5. The method of claim 1, wherein the sublimation printing substance is deposited on a front side of the print medium and wherein the air flow passes through the print medium from a backside to the front side.

6. A heating system for sublimation printing, the heating system comprising:
a flow generator o generate an air flow;
a heater to heat the air flow; and
a frame to place an air-permeable print medium such that the heated air flow passes through the print medium.

7. The heating system of claim 6, wherein the heater comprises a heating grid and wherein the air flow passes through the heating grid.

8. The heating system of claim 7, wherein the heating grid comprises a resistive electric heating element having a material with an electric resistance with a positive temperature coefficient.

9. The heating system of claim 6, further comprising a controller, wherein
the heater comprises a resistive heating element,
the flow generator comprises a fan, and
the controller adjusts a fan speed of the fan and a current through the resistive heating element.

10. The heating system of claim 6, wherein the heater heats the air flow to a temperature between 200° C. and 300° C.

11. A printing device comprising:
a print head to deposit a sublimation printing substance on an air-permeable print medium; and
a heating subsystem to heat the print medium, wherein the heating subsystem comprises a flow generator to generate an air flow through the print medium and a heater to heat the air flow.

12. The printing device of claim 11, further comprising an actuator to move the print medium from a printing zone adjacent to the print head to a sublimation zone adjacent to the heating subsystem.

13. The printing device of claim 11, wherein the print head is part of a printing subsystem and wherein the printing subsystem and the heating subsystem are independent systems.

14. The printing device of claim 11, further including a frame to fix the air-permeable medium such that the heated air flow passes through the print medium.

15. The printing device of claim 14, wherein the frame is detachably connected to the heating subsystem.
